(19) United States
(12) Patent Application Publication
(10) Pub. No.: US 2026/0025005 A1
(43) Pub. Date: Jan. 22, 2026

(54) RECHARGEABLE BATTERY OUTPUT EXTENSION CIRCUIT AND METHOD OF USE

(71) Applicant: Carlos A. Sorondo, Sr., Whitestone, NY (US)

(72) Inventor: Carlos A. Sorondo, Sr., Whitestone, NY (US)

(21) Appl. No.: 18/774,485

(22) Filed: Jul. 16, 2024

(51) Int. Cl. H02J 7/34; H02J 7/00

(52) U.S. Cl. CPC H02J 7/345; H02J 7/0025; H02J 7/00712; H02J 7/342; H02J 2207/20; H02J 2207/50; H02J 2310/48

(57) ABSTRACT

The battery output extension circuit has a switch to supply energy from a first rechargeable battery to charge a capacitor and a second rechargeable battery and then interrupt that supply of energy. The battery output extension circuit has another switch to subsequently enable energy to be discharged from the capacitor to power a load. The sequential charging of the capacitor and the second rechargeable battery, interruption of the charging, and subsequent discharging of the capacitor to power a load is repeatedly performed. A switching configuration can reverse the direction of charging such that the second rechargeable battery supplies the energy to perform a similar repeatedly performed sequential charging of the capacitor and the first rechargeable battery, interruption of the charging, and subsequent discharging of the capacitor to power the load.

### BACKGROUND OF THE INVENTION

### Field of the Invention

The invention generally relates to the field of rechargeable batteries. More specifically, the invention relates to a circuit for recharging rechargeable batteries and for powering a load.

### SUMMARY OF THE INVENTION

Rechargeable batteries have a limited time during which the batteries can provide power to a load or device before requiring recharging by a charging station or some type of charging device. Also, depending on the application, one or more batteries of a certain size and/or a certain number of batteries or battery banks, which are constructed from a plurality of batteries, are required to satisfy the power demands of a particular load or device.

In many applications, there is a need to increase the time during which one or more rechargeable batteries can provide power to a load or device before the rechargeable battery or batteries require recharging by a charging station or charging device.

For example, in electrically powered moving vehicle applications, it is desirable to extend the range or distance that an electric vehicle can travel on one charge of one or more rechargeable batteries powering the electric motor that provides the motive force to move the electric vehicle. An electrically powered moving vehicle or electric vehicle is understood to be a vehicle with an electric motor configured to provide the motive force required to move the electric vehicle. A non-exhaustive list of types of electric vehicles includes, for example, automobiles, trucks, boats, airplanes, and other well-known vehicles.

As a particular example, it is desirable to extend the range or distance that an electrically powered automobile can travel on one charge of one or more rechargeable batteries powering the electric motor that provides the motive force to move the automobile.

In some electrically powered moving vehicle applications, it might alternatively or additionally be desirable to operate an electric vehicle for a certain range or distance by using a lower number of rechargeable batteries compared to the number of rechargeable batteries required in the prior art to be able to operate the electric vehicle for that same range or distance.

In some electrically powered moving vehicle applications, it might alternatively or additionally be desirable to operate an electric vehicle for a certain range or distance by using one or more rechargeable batteries constructed to have a smaller size or smaller sizes compared to the size or sizes of the one or more rechargeable batteries required in the prior art to be able to operate the electric vehicle for that same range or distance.

Using a lower number of rechargeable batteries compared to the number of rechargeable batteries used in electric vehicles in the prior art and/or using rechargeable batteries that are constructed with smaller sizes compared to the size requirements of the rechargeable batteries used in electric vehicles in the prior art is advantageous not just from the viewpoint of lowering the cost of the battery or batteries used in the electric vehicle, but also from the perspective of lowering the weight of the battery or batteries carried on the electric vehicle. Lowering this weight may, for example, increase the range of the electric vehicle, enable the use of a less expensive chassis with lower weight supporting requirements compared to the prior art, and/or enable the use of an electric motor with lower weight moving requirements compared to the weight moving requirements placed on such an electric motor in the prior art.

In addition to electrically powered moving vehicle applications, similar efforts can be made regarding powering residential or commercial buildings. For example, it is typically desirable to extend the time or duration that a rechargeable battery or a plurality of rechargeable batteries can power a load or loads in a building before requiring recharging. Additionally, or alternatively, it is desirable to use one or more rechargeable batteries constructed to have a smaller size(s) compared to the requirements in the prior art to power the same load or loads for the same duration. Likewise, it might additionally or alternatively be desirable to use a lower number of batteries to power load or loads in a building compared to the requirements in the prior art.

The battery output extension circuit disclosed herein is based on extending the output of rechargeable batteries using a unique property of a capacitor that Maxwell called displacement current. Specifically, the output of rechargeable batteries is extended by utilizing energy that is stored in a capacitor due to an electric field created by a voltage that is applied across the plates of a capacitor. Energy is stored in the capacitor without a current flowing through the capacitor from one plate to the other plate.

The battery output extension circuit disclosed herein can be implemented with a first rechargeable battery and a second rechargeable battery. However, each battery, i.e. the first rechargeable battery and the second rechargeable battery can be replaced with a respective battery bank constructed from a plurality of rechargeable batteries.

Typically, a first rechargeable battery and a second rechargeable battery will be initially fully charged. Then one of the batteries, namely, the first rechargeable battery or the second rechargeable battery is used to power a load or device until that battery requires recharging. In the following description, it is assumed that the second rechargeable battery was used to power a load or device and the second rechargeable battery now requires recharging.

The battery output extension circuit disclosed herein is based on the following method of operation.

While a first rechargeable battery recharges a second rechargeable battery, a voltage obtained from the first rechargeable battery is also used to create an electric field across the plates of a capacitor to thereby charge the capacitor. In the case where battery banks are used instead of single batteries, then likewise while a first rechargeable battery bank constructed from a plurality of rechargeable batteries recharges a second rechargeable battery bank constructed from a plurality of rechargeable batteries, a voltage obtained from the first rechargeable battery bank is also used to create an electric field across the plates of the capacitor to thereby charge (or recharge) the capacitor.

In the text that follows the terms “charging” and “recharging” might be used interchangeably. In both cases, it should be clear that components, such as a capacitor and one or more batteries or a battery bank are being charged. For example, it is assumed that the batteries will initially be charged, so the process of charging a battery can be considered to be recharging. Also, after the very first time the capacitor is charged, the process of charging the capacitor can be considered to be recharging. However, in both cases, the capacitor and one or more batteries (or a battery bank) are being charged.

At a certain point in time, the charging (or equivalently recharging) of the capacitor and the second rechargeable battery (or a second rechargeable battery bank) is interrupted, and the energy stored in the plates of the capacitor is subsequently used to power a load or device. This certain point in time at which the charging of the capacitor and the second rechargeable battery (or a second rechargeable battery bank) is interrupted can be dynamically based on values that are measured in the battery output extension circuit or it can be predetermined using known electrical properties of electrical components used in the battery output extension circuit.

For example, this certain point in time can be dynamically based on values of one or more measured power flows in the battery output extension circuit. As another example, this certain point in time can be predetermined to be the first RC time constant that determines the time for the voltage across the capacitor to reach 63.2% of the voltage applied to it during this duration (in determining the first RC time constant, C is the capacitance of the capacitor and R is the resistance of the circuit determining the charging and discharging of the capacitor).

At a subsequent point in time that is after the time at which the energy stored in the plates of the capacitor begins to be used to power a load or device, the flow of energy from the capacitor to the load or device is interrupted and then the charging (or recharging) of the capacitor and the second rechargeable battery from the first rechargeable battery is continued. Likewise, if battery banks are used instead of single batteries, the flow of energy from the capacitor to the load or device is interrupted at the subsequent point in time, and then the charging (or recharging) of the capacitor and the second rechargeable battery bank from the first rechargeable battery bank is continued.

The subsequent point in time at which the discharging of the capacitor to power the load is interrupted can be determined in a way similarly to that described above regarding the certain point in time at which the charging of the capacitor is interrupted. Specifically, the subsequent point in time at which the discharging of the capacitor to power the load is interrupted can be dynamically based on values that are measured in the battery output extension circuit or the subsequent point in time can be predetermined using known electrical properties of electrical components in the battery output extension circuit.

For example, the subsequent point in time can be dynamically based on values of one or more measured power flows in the battery output extension circuit. As another example, this subsequent point in time can be predetermined to be the first RC time constant that determines the time for the voltage across the capacitor to reach 63.2% of the voltage applied to it during this duration (in determining the first RC time constant, C is the capacitance of the capacitor and R is the resistance of the circuit determining the charging and discharging of the capacitor).

This sequential process of, in the following order: charging the capacitor and the second rechargeable battery bank, subsequently interrupting the charging of the capacitor and the second rechargeable battery bank, subsequently discharging the capacitor to power a load or device, subsequently interrupting the powering of the load or device by the capacitor, and then going back to continue charging the capacitor and the second rechargeable battery bank can be sequentially repeated until a point in time where it is determined from one or more measured values, such as, one or more measured power flows, that the charging from the first rechargeable battery to the second rechargeable battery should be reversed. In the case where rechargeable battery banks are used, the described sequential process is repeated until a point in time where it is determined from one or more measured values, such as, one or more measured power flows, that the charging from a first rechargeable battery bank to a second rechargeable battery bank should be reversed.

For example, perhaps the power flowing out of the first rechargeable battery (or first rechargeable battery bank) has reached a level below a threshold value, or perhaps the power flowing into the second rechargeable battery (or second rechargeable battery bank) has reached a level below a threshold value. Reversing the charging direction should be understood to mean that the second rechargeable battery (or second rechargeable battery bank) now charges (or equivalently recharges) the first rechargeable battery (or first rechargeable battery bank) and the capacitor. The process is analogous to that already described, but it will be described in detail below for clarity.

While the second rechargeable battery charges the first rechargeable battery, a voltage obtained from the first rechargeable battery is also used to create an electric field across the plates of the capacitor to thereby also charge the capacitor. Likewise, if battery banks are used instead of single batteries, while the second rechargeable battery bank charges the first rechargeable battery bank, a voltage obtained from the first rechargeable battery bank is also used to create an electric field across the plates of the capacitor to thereby also charge the capacitor. At a certain point in time, the charging (or recharging) of the capacitor and the first rechargeable battery (or first rechargeable battery bank is interrupted), and the energy from the electric field formed across the plates of the capacitor is then used to power the load or device. Then, at a subsequent point in time, which is subsequent to the previously described certain point in time and to the previously described powering of the load or device, the flow of energy from the capacitor to the load or device is interrupted and then the charging of the first rechargeable battery (or first rechargeable battery bank) and the capacitor from the second rechargeable battery (or second rechargeable battery bank) is continued.

This sequential process of initially charging the first rechargeable battery (or first rechargeable battery bank) and the capacitor, interrupting the charging, subsequently discharging the capacitor to power the load or device, subsequently interrupting the powering of the load or device by the capacitor, and then going back to continue charging the first rechargeable battery (or first rechargeable battery bank) and the capacitor is sequentially repeated until a point in time where it is determined from one or more measured values, such as, one or more measured power flows, that the charging direction should be reversed. For example, perhaps the power flowing out of the second rechargeable battery (or second rechargeable battery bank) has reached a level below a threshold value, or perhaps the power flowing into the first rechargeable battery (or first rechargeable battery bank) has reached a level below a threshold value. Reversing the charging direction in this process should now be understood to mean that the first rechargeable battery (or first rechargeable battery bank) now charges the second rechargeable battery (or second rechargeable battery bank) and the capacitor as already described.

The described charging (or recharging) and discharging of the rechargeable batteries or rechargeable battery banks can continue for the lifetime of the batteries or battery banks.

The level of the voltage being discharged from the capacitor is not necessarily increased but is preferably increased to a higher voltage level to power the load or device.

The level of the voltage discharged by the capacitor can be increased using a voltage level booster that can be implemented, for example, as a boost converter (switched mode DC-DC converter for stepping up the voltage applied thereto), a step-up transformer, a coil, or a combination of the listed components. The voltage level booster can also be implemented with other functionally equivalent devices.

When the voltage level booster is a boost converter acting to increase the level of the voltage being discharged from the capacitor, the switch implementing the switching in this boost converter is preferably used to create or close a current path from the capacitor to the load or device being powered by the voltage discharged from the capacitor.

Similarly, the level of the voltage supplied by one or more rechargeable batteries (a single rechargeable battery, a plurality of rechargeable batteries, or a rechargeable battery bank constructed from a plurality of rechargeable batteries) to charge another one or more rechargeable batteries (a single rechargeable battery, a plurality of rechargeable batteries, or a rechargeable battery bank constructed from a plurality of rechargeable batteries) is not necessarily increased but is preferably increased by another voltage level booster. This voltage level booster, which boosts the level of the voltage from one or more batteries, can be implemented, for example, as a boost converter (switched mode DC-DC converter for stepping up the voltage applied thereto), a step-up transformer, a coil, or a combination of the listed components. This voltage level booster can also be implemented with other functionally equivalent devices.

Instead of using a voltage level booster to increase the level of the voltage supplied for charging, the voltage level that is supplied for charging can be increased by appropriately connecting a plurality of rechargeable batteries, which supply charging energy, in series. In this way, each additional rechargeable battery that is connected in series increases the level of the voltage that is available across all the rechargeable batteries connected in series. The plurality of rechargeable batteries connected in series can be only some of the rechargeable batteries used to supply charging energy. For example, at least some of the rechargeable batteries of a battery bank, which will be connected to supply charging energy, can be connected in series to increase the level of the voltage that is applied to the other rechargeable battery bank being charged and to charge the capacitor.

The rechargeable batteries used in the exemplary embodiments of the battery output extension circuit described herein may be any known rechargeable batteries. For example, lithium-ion batteries, such as lithium polymer cell batteries can be used. However, in some applications, low-cost Nickel Metal Hydride cell batteries or lead-acid batteries can be used due to the increase in performance resulting from the battery output extension circuit.

Herein, references to a battery or to batteries without a specific reference to being rechargeable should nevertheless be understood to refer to a rechargeable battery or to rechargeable batteries, respectively.

With the foregoing and other objects in view, there is provided a first exemplary embodiment of a battery output extension circuit. This embodiment of the battery output extension circuit includes at least the following described components. A first rechargeable battery has an electrode electrically connected to a reference potential and has a further electrode. A second rechargeable battery has an electrode electrically connected to the reference potential and has a further electrode. A first boost converter has an input and an output. A first switch implements a switching required for voltage boosting in the first boost converter. A second boost converter has an input and an output providing an output voltage for a load. A second switch implements a switching required for voltage boosting in the second boost converter. A capacitor has a terminal connected to the reference potential and has a further terminal connected to the input of the second boost converter. A third switch has a terminal connected to the further electrode of the first rechargeable battery, a terminal connected to the further electrode of the second rechargeable battery, and a terminal connected to the output of the first boost converter. The third switch is configured for selectively connecting the further electrode of the second rechargeable battery to the output of the first boost converter and is configured for alternately selectively connecting the further electrode of the first rechargeable battery to the output of the first boost converter. A fourth switch has a terminal connected to the further electrode of the first rechargeable battery, a terminal connected to the further electrode of the second rechargeable battery, and a terminal connected to the input of the first boost converter. The fourth switch is configured for selectively connecting the further electrode of the first rechargeable battery to the input of the first boost converter and is configured for alternately selectively connecting the further electrode of the second rechargeable battery to the input of the first boost converter. An electronic controller is configured for controlling the fourth switch such that an electrode selected from the group consisting of the further electrode of the first rechargeable battery and the further electrode of the second rechargeable battery is connected to the input of the first boost converter while the electronic controller concurrently controls the third switch such that a different electrode selected from the group consisting of the further electrode of the first rechargeable battery and the further electrode of the second rechargeable battery is connected to the output of the first boost converter. The electronic controller is configured for controlling the first switch to selectively connect the further terminal of the capacitor to the first boost converter to charge the capacitor and to disconnect the further terminal of the capacitor from the first boost converter to stop charging the capacitor. The electronic controller is configured for controlling the second switch to enable a charge stored in the capacitor to be discharged into the input of the second boost converter while the further terminal of the capacitor is disconnected from the first boost converter. The electronic controller is also configured for controlling the second switch to disable the charge stored in the capacitor from being discharged into the input of the second boost converter.

In accordance with an added feature of the invention, the reference potential is at a ground potential.

In accordance with an additional feature of the invention, the electronic controller is configured to control the first switch and the second switch by controlling a frequency and/or a duty cycle of control signals supplied to the first switch and the second switch.

In accordance with another feature of the invention, the electronic controller is configured to determine the frequency and/or the duty cycle of control signals based on measured values that are measured in the battery output extension circuit.

In accordance with a further feature of the invention, the measured values include a power being supplied to the capacitor and/or a power supplied by the capacitor.

In accordance with an added feature of the invention, the measured values include a power being supplied by a battery selected from the group consisting of the first rechargeable battery and the second rechargeable battery.

In accordance with an additional feature of the invention, the measured values include a power being supplied to a battery selected from the group consisting of the first rechargeable battery and the second rechargeable battery.

In accordance with another feature of the invention, the electronic controller is a processor and a memory.

In accordance with a further feature of the invention, the first switch is a semiconductor switch, and the second switch is a semiconductor switch.

In accordance with a further added feature of the invention, the third switch is a relay, and the fourth switch is a relay.

In accordance with a further additional feature of the invention, any of the exemplary embodiments of the battery output extension circuit may include a first watt meter providing at least one measured value selected from the group consisting of a power flowing into the first rechargeable battery and a power flowing out of the first rechargeable battery; and a second watt meter providing at least one measured value selected from the group consisting of a power flowing into the second rechargeable battery and a power flowing out of the second rechargeable battery. The electronic controller is configured for controlling the switching of the first switch and the switching of the second switch based on the at least one measured value provided by the first watt meter and on the at least one measured value provided by second first watt meter.

In accordance with yet a further feature of the invention, any of the exemplary embodiments of the battery output extension circuit may include the load in the form of an electric motor.

Any of the previously described features can also be features of the additionally described exemplary embodiments of the battery output extension circuit.

With the foregoing and other objects in view, there is provided a second exemplary embodiment of the battery output extension circuit. This embodiment of the battery output extension circuit includes at least the following described components. A first rechargeable battery has an electrode electrically connected to a reference potential and has a further electrode. A second rechargeable battery has an electrode electrically connected to the reference potential and has a further electrode. A first voltage level booster has an input and an output. A second voltage level booster has an input and an output providing an output voltage for a load. A first switch and a second switch are components of the circuit. A capacitor has a terminal connected to the reference potential and has a further terminal connected to the input of the second voltage level booster. A third switch has a terminal connected to the further electrode of the first rechargeable battery, a terminal connected to the further electrode of the second rechargeable battery, and a terminal connected to the output of the first voltage level booster. The third switch is configured for selectively connecting the further electrode of the second rechargeable battery to the output of the first voltage level booster and for alternately selectively connecting the further electrode of the first rechargeable battery to the output of the first voltage level booster. A fourth switch has a terminal connected to the further electrode of the first rechargeable battery, a terminal connected to the further electrode of the second rechargeable battery, and a terminal connected to the input of the first voltage level booster. The fourth switch is configured for selectively connecting the further electrode of the first rechargeable battery to the input of the first voltage level booster and for alternately selectively connecting the further electrode of the second rechargeable battery to the input of the first voltage level booster. An electronic controller is configured for controlling the fourth switch such that an electrode selected from the group consisting of the further electrode of the first rechargeable battery and the further electrode of the second rechargeable battery is connected to the input of the first voltage level booster while concurrently controlling the third switch such that a different electrode selected from the group consisting of the further electrode of the first rechargeable battery and the further electrode of the second rechargeable battery is connected to the output of the first voltage level booster. The electronic controller is configured for controlling the first switch to selectively connect the further terminal of the capacitor to the first voltage level booster to charge the capacitor and to disconnect the further terminal of the capacitor from the first voltage level booster to stop charging the capacitor. The electronic controller is configured for controlling the second switch to enable a charge stored in the capacitor to be discharged into the input of the second voltage level booster while the further terminal of the capacitor is disconnected from the first voltage level booster. The electronic controller is also configured for controlling the second switch to disable the charge stored in the capacitor from being discharged into the input of the second voltage level booster.

In accordance with an added feature of the invention, the first voltage level booster is a step-up transformer, and the second voltage level booster is a step-up transformer.

In accordance with an additional feature of the invention, the first voltage level booster is a boost converter, and the second voltage level booster is a boost converter.

In accordance with a further feature of the invention, a plurality of watt meters is configured for supplying measured values to the electronic controller, and the electronic controller is configured for controlling the first switch and the second switch based on the measured values from the plurality of watt meters.

In accordance with a further added feature of the invention, a plurality of sensors is configured for supplying measured values to the electronic controller, and the electronic controller is configured for controlling the first switch and the second switch based on the measured values from the plurality of sensors.

With the foregoing and other objects in view, there is provided a third exemplary embodiment of the battery output extension circuit. This embodiment of the battery output extension circuit includes at least the following described components. A first rechargeable battery pack has an electrode electrically connected to a reference potential, a further electrode, and a plurality of batteries connected in series between the electrode and the further electrode. A second rechargeable battery pack has an electrode electrically connected to a reference potential, a further electrode, and a plurality of batteries connected in series between the electrode and the further electrode. A first boost converter has an input and an output. A capacitor has a terminal connected to the reference potential and has a further terminal providing an output voltage for a load. A third switch has a terminal connected to the further electrode of the first rechargeable battery, a terminal connected to the further electrode of the second rechargeable battery, and a terminal connected to the output of the first boost converter. The third switch is configured for selectively connecting the further electrode of the second rechargeable battery to the output of the first boost converter and for alternately selectively connecting the further electrode of the first rechargeable battery to the output of the first boost converter. A fourth switch has a terminal connected to the further electrode of the first rechargeable battery, a terminal connected to the further electrode of the second rechargeable battery, and a terminal connected to the input of the first boost converter. The fourth switch is configured for selectively connecting the further electrode of the first rechargeable battery to the input of the first boost converter and for alternately selectively connecting the further electrode of the second rechargeable battery to the input of the first boost converter. An electronic controller is configured for controlling the fourth switch such that an electrode selected from the group consisting of the further electrode of the first rechargeable battery and the further electrode of the second rechargeable battery is connected to the input of the first boost converter while the electronic controller concurrently controls the third switch such that a different electrode selected from the group consisting of the further electrode of the first rechargeable battery and the further electrode of the second rechargeable battery is connected to the output of the first boost converter. The electronic controller is configured for controlling the first switch to selectively connect the further terminal of the capacitor to the first boost converter to charge the capacitor and to disconnect the further terminal of the capacitor from the first boost converter to stop charging the capacitor. The electronic controller is configured for controlling the second switch to enable a charge stored in the capacitor to be discharged into the load while the further terminal of the capacitor is disconnected from the first boost converter. The electronic controller is configured for controlling the second switch to disable the charge stored in the capacitor from being discharged into the load.

The battery output extension circuit has been described with only one capacitor, but typically thousands of capacitors will be charged.

### BRIEF DESCRIPTION OF THE DRAWINGS

FIG. 1 is a schematic diagram of a first exemplary embodiment of a battery output extension circuit switched to be in a first operating mode;

FIG. 2 is a schematic diagram of the first exemplary embodiment of the battery output extension circuit switched to be in a second operating mode;

FIG. 3 is a schematic diagram of a second exemplary embodiment of the battery extension circuit switched to be in a first operating mode;

FIG. 4 is a schematic diagram of the second exemplary embodiment of the battery extension circuit switched to be in a second operating mode;

FIG. 5 is a diagram showing waveforms for controlling the first and second switches;

FIG. 6 shows a circuit that was used to perform an experiment;

FIG. 7 shows the active parts of circuit in FIG. 6 when one switch is closed; and

FIG. 8 shows the active parts of circuit in FIG. 6 when the other switch is closed.

### DETAILED DESCRIPTION OF THE INVENTION

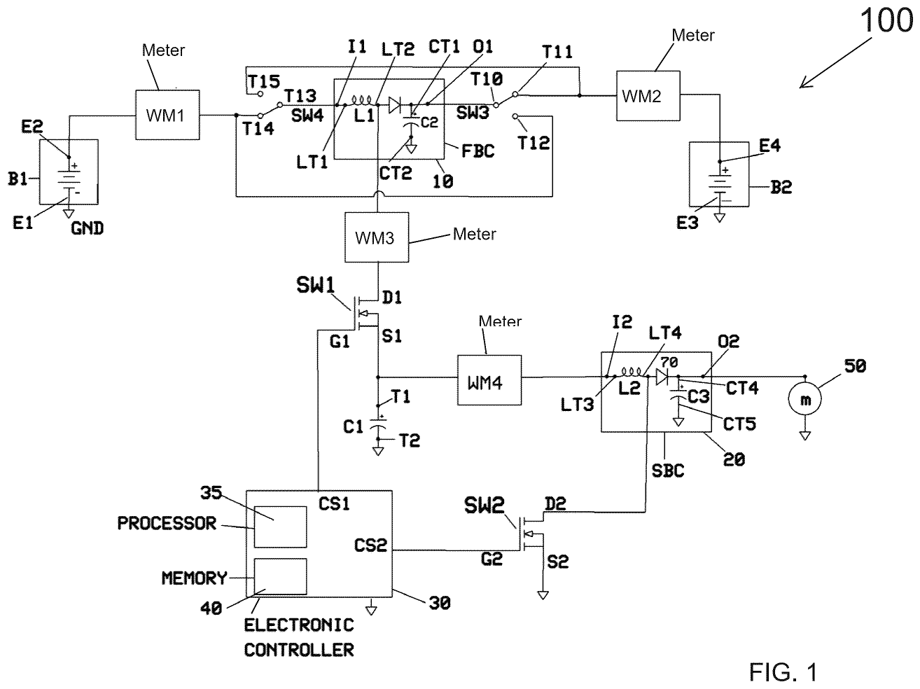

FIG. 1 is a schematic diagram of a first exemplary embodiment of the battery output extension circuit 100. FIG. 1 shows only a first rechargeable battery B1 and a second rechargeable battery B2. However, the first rechargeable battery B1 can be replaced with a plurality of rechargeable batteries connected in series, in parallel, or in some combination of parallel and serial connections. Likewise, the second rechargeable battery B2 can be replaced with a plurality of batteries connected in series, in parallel, or in some combination of parallel and serial connections. A plurality of rechargeable batteries connected in one of the described ways can form a battery bank.

The first exemplary embodiment of the battery output extension circuit 100 operates in a first operating mode and in a second operating mode depending on the switching states of the third switch SW3 and the fourth switch SW4.

FIG. 1 is used to illustrate the situation where the second rechargeable battery B2 has been drained after powering the load 50 and requires charging. FIG. 1 shows the first exemplary embodiment of the battery output extension circuit 100 switched into and operating in the first operating mode in which energy from the first rechargeable battery B1 is used to charge the second rechargeable battery B2 and a capacitor C1.

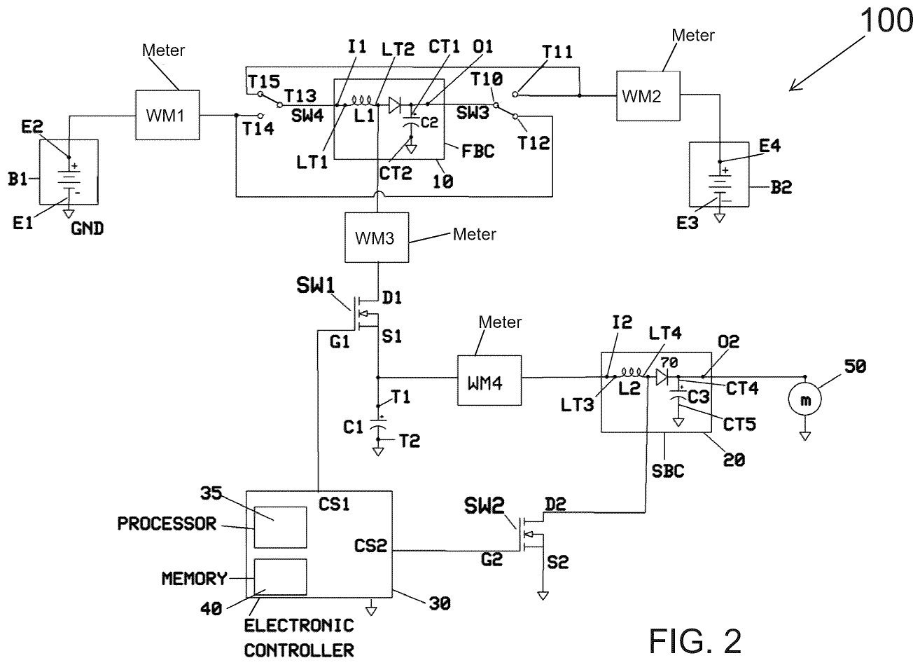

FIG. 2 is used to illustrate the situation where the first rechargeable battery B1 has been drained after powering the load 50 and requires charging. FIG. 2 is a schematic diagram of the first exemplary embodiment of the battery output extension circuit 100 shown switched into and operating in the second operating mode in which energy from the second rechargeable battery B2 is used to charge the first rechargeable battery B1 and the capacitor C1.

The first exemplary embodiment of the battery output extension circuit 100 includes at least: the first rechargeable battery B1, the second rechargeable battery B2, the capacitor C1, a first switch SW1, a second switch SW2, the third switch SW3, the fourth switch SW4, a first voltage level booster 10, a second voltage level booster 20, and an electronic controller 30.

The terms “voltage level booster” should be construed to be any known circuit that can boost the level of the DC voltage applied thereto. For example, the “voltage level booster” can be a boost converter (switched mode DC-DC converter for stepping up the voltage applied thereto), a step-up transformer, a coil, or a combination of the listed components.

In the first exemplary embodiment of the battery output extension circuit 100 shown in FIGS. 1 and 2, the first voltage level booster 10 is implemented as a first boost converter FBC (switched mode DC-DC converter for stepping up the voltage applied thereto), and the second voltage level booster 20 is implemented as a second boost converter SBC (switched mode DC-DC converter for stepping up the voltage applied thereto).

The electronic controller 30 is preferably formed by at least a processor 35 and a memory 40 that are operatively and functionally connected to operate in manner sufficient to control the switching, charging, and discharging operations described herein.

The first exemplary embodiment of the battery output extension circuit 100 is constructed to power a load 50 connected thereto. This load 50 can be, for example, an electric motor M providing the motive force to move an automobile or any other type of vehicle capable of moving. The load 50 can alternatively be, for example, one or more types of loads in a residential or commercial building. Such loads 50 include, for example, air conditioning units, lighting equipment, appliances, such as refrigerator/freezers, and/or any other type of load that can be in such buildings.

Additional components and features may be added to any of the exemplary embodiments of the battery output extension circuit, without departing from the invention, given that the changes do not prevent the resulting battery output extension circuit from operating to charge one or more batteries while charging at least the capacitor C1 and from then powering a load 50 by discharging the energy stored in at least the capacitor C1.

The first rechargeable battery B1 has a negative electrode E1 connected to a reference potential GND, and the second rechargeable battery B2 has a negative electrode E3 connected to the reference potential GND. The reference potential GND is preferably ground potential.

The battery output extension circuit does not necessarily have to be constructed with voltage level boosters. However, the first exemplary embodiment of the battery output extension circuit 100 shown in FIGS. 1 and 2 includes a first voltage level booster 10 with an input I1 and an output O1, and a second voltage level booster 20 with an input 12 and an output O2.

The first voltage level booster 10 is shown implemented as a first boost converter FBC in FIGS. 1 and 2, but it can be implemented in other ways. The first boost converter FBC includes an inductor L1, a diode 60, and a capacitor C2. The first switch SW1 is provided to implement the switching required for operating the first boost converter FBC and to control the charging of the capacitor C1. The first terminal LT1 of the inductor L1 forms the input I1 of the first boost converter FBC. The node, which connects the cathode of the diode 60 and the first terminal CT1 of the capacitor C2, forms the output O1 of the first boost converter FBC. The second terminal CT2 of the capacitor C2 is connected to the reference potential GND.

The first terminal D1 of the first switch SW1 is connected to the node that is connected to the second terminal LT2 of the inductor L1 and to the anode of the diode 60 of the first boost converter FBC. The first terminal D1 of the first switch SW1 is connected to the conductive path that may be formed in or by the first switch SW1 by applying a control signal, which is labeled as a first control signal CS1, to the control terminal G1 of the first switch SW1. The second terminal S1 of the first switch SW1 is connected to the first terminal T1 of the capacitor C1. The second terminal S1 of the first switch SW1 is connected to the other end of the conductive path which may be formed in or by the first switch SW1. The second terminal T2 of the capacitor C1 is connected to the reference potential GND.

The first terminal T13 of the fourth switch SW4 is connected to the first terminal LT1 of the inductor L1. The node, which connects the cathode of the diode 60 and the first terminal CT1 of the capacitor C2, is connected to the first terminal T10 of the third switch SW3.

The second voltage level booster 20 is shown implemented as a second boost converter SBC in FIGS. 1 and 2, but it can be implemented in other ways. The load 50 is connected between the output O2 of the second boost converter SBC and the reference potential GND.

The second boost converter SBC includes an inductor L2, a diode 70, and a capacitor C3. The second switch SW2 implements the switching that is required for the functioning of the second boost converter SBC and also controls the discharging of the capacitor C1 so the capacitor C1 can power the load 50.

The first terminal LT3 of the inductor L2 forms the input 12 of the second voltage level booster 20. The node, which connects the cathode of the diode 70 and the first terminal CT4 of the capacitor C3, forms the output O2 of the second voltage level booster 20. The second terminal CT5 of the capacitor C3 is connected to the reference potential GND.

The first terminal D2 of the second switch SW2 is connected to the node that is connected to the second terminal LT4 of the inductor L2 and to the anode of the diode 70 of the second boost converter SBC. The first terminal D2 and the second terminal S2 of the second switch SW2 are each connected to the conductive path that can be switchably formed in or by the second switch SW2 by applying a control signal, which is labeled as a second control signal CS2, to the control terminal G2 of the second switch SW2. The second terminal S2 of the second switch SW2 is connected to the reference potential GND.

The first switch SW1 and the second switch SW2 are preferably implemented by semiconductor switches, for example, metal oxide field effect transistors (MOSFETs). When the first switch SW1 is implemented as a MOSFET, as shown in FIGS. 1 and 2, a conductive path is formed between the first terminal S1 (source) and the second terminal D1 (drain) of the field effect transistor in response to a control signal CS1 applied to the control terminal G1 (gate). The same is true when the second switch SW2 is implemented as a MOSFET, as shown in FIGS. 1 and 2. However, the first switch SW1 and the second switch SW2 can be implemented by other switching components that are well known or that will become well known in the art.

The third switch SW3 and the fourth switch SW4 can each be constructed as a single pole double throw (SPDT) switch. The third switch SW3 and the fourth switch SW4 may each be implemented as a relay or with semiconductor components, such as MOSFETs. The third switch SW3 has a control terminal (non-illustrated) that controls the switching of the third switch SW3 and the fourth switch SW4 has a control terminal (non-illustrated) that controls the switching of the fourth switch SW4.

The electronic controller 30 generates a third control signal (non-illustrated) and supplies it to the control terminal of the third switch SW3 and the electronic controller 30 generates a fourth control signal (non-illustrated) and supplies it to the control terminal of the fourth switch SW4.

The third control signal and the fourth control signal determine whether the battery output extension circuit 100 operates in the first operating mode in which energy from the first rechargeable battery B1 is used to charge the second rechargeable battery B2 and the capacitor C1, or whether the battery output extension circuit 100 operates in the second operating mode in which energy from the second rechargeable battery B2 is used to charge the first rechargeable battery B1 and the capacitor C1. In both the first operating mode and the second operating mode, energy is first stored in the capacitor C1 during the recharging of one of the batteries (B2 or B1) from the other one of the batteries (B1 or B2). In both the first operating mode and the second operating mode, after the recharging operation is interrupted, the energy that is stored in the capacitor C1 can subsequently be discharged to power the load 50. The storage of energy in the capacitor C1 during the recharging of one of the batteries (B2 or B1), and the subsequent discharging of the energy stored in the capacitor C1 to power the load 50 are alternatingly performed. The alternating process is repeated as long as practical given the charge state of the battery (B1 or B2) supplying the recharging energy. The process is performed at a rate sufficient to continually satisfy the power requirements of the load 50.

FIG. 1 shows the first exemplary embodiment of the battery output extension circuit 100 in which a non-illustrated third control signal has actuated the third switch SW3 and a non-illustrated fourth control signal has actuated the fourth switch SW4 such that the exemplary embodiment of the battery output extension circuit 100 operates in the first operating mode.

In the first operating mode shown in FIG. 1, the fourth control signal has actuated the fourth switch SW4 to electrically connect the positive electrode E2 of the first rechargeable battery B1 to the input I1 of the first boost converter FBC by electrically connecting the first terminal T13 of the fourth switch SW4 to the second terminal T14 of the fourth switch SW4.

In the first operating mode shown in FIG. 1, the third control signal has actuated the third switch SW3 to electrically connect the output O1 of the first boost converter FBC to the positive electrode E4 of the second rechargeable battery B2 by electrically connecting the first terminal T10 of the third switch SW3 to the third terminal T11 of the third switch SW3.

The first boost converter FBC boosts the DC voltage supplied by the first rechargeable battery B1 to a DC voltage having a level that is sufficient for charging the second rechargeable battery B2. In this way, energy from the first rechargeable battery B1 is used to charge the second rechargeable battery B2. During this recharging process, the control terminal G1 of the first switch SW1 receives a first control signal from the electronic controller 30 causing the first switch SW1 to electrically connect the DC voltage supplied by the first rechargeable battery B1 to the first terminal T1 of the capacitor C1. Thus, while energy from the first rechargeable battery B1 recharges the second rechargeable battery B2, the capacitor C1 is also charged.

Up to a practical limit, increasing the level of the DC voltage used to charge a respective battery (B2 or B1) and the capacitor C1 generally increases the efficiency of the charging performed by the battery output extension circuit 100.

As one non-limiting example, let us consider the case in which the battery output extension circuit 100 charges not only a singly battery like battery B2 shown in FIG. 1, but will charge a plurality of batteries connected in series. In this case, good charging efficiency is obtained when setting the level of the DC voltage to 300 V to charge the capacitor C1 and the plurality of batteries connected in series.

The duration of charging the capacitor C1 can be determined by measuring electrical values in the first exemplary embodiment of the battery output extension circuit 100 or it can simply be determined by the known electrical properties of electrical components in first the exemplary embodiment of the battery output extension circuit 100. For example, the duration of recharging the capacitor C1 can simply be set to be equal to the first RC time constant, where C is the capacitance of the capacitor C1 and R is the resistance of the inductor L1 in the first boost converter FBC. This results in acceptable operation since the voltage across the capacitor C1 will reach 63.2% of the voltage applied to it during this duration.

The duration of charging the capacitor C1 can additionally or alternatively be determined by measuring electrical values using various sensors. For example, powers and/or currents could be measured in the first exemplary embodiment of the battery output extension circuit 100. An optimized implementation is based on determining the duration of charging the capacitor C1 by measuring the power flowing into or out of certain points in the first exemplary embodiment of the battery output extension circuit 100. As one specific example, the power flowing into the capacitor C1 during charging can be measured by the third watt meter WM3 and the duration of charging of the capacitor C1 can be ended when the measured power flowing into the capacitor C1 has fallen to a predetermined power level.

To end the duration during which the capacitor C1 is charging, the first control signal CS1 generated by the electronic controller 30 and sent to the control terminal G1 of first switch SW1 causes the conductive path formed in or by the first switch SW1 to open (i.e., causes the path to no longer be formed) to thereby electrically disconnect the first terminal T1 of the capacitor C1 from the positive electrode E2 of the first rechargeable battery B1.

As soon as the conductive path in the first switch SW1 is open, a conductive path is formed in or by the second switch SW2 as a result of a second control signal CS2 generated by the electronic controller 30 and supplied to the control terminal G2 of the second switch SW2. When the conductive path of the second switch SW2 is formed, the charge stored in the capacitor C1 discharges into the input 12 of the second boost converter SBC. The output O2 of the second boost converter SBC is electrically connected to the load 50. The second boost converter SBC converts the voltage supplied to the input 12 of the second boost converter SBC by the capacitor C1 to a voltage having a voltage level suitable for powering the load 50. This voltage, which is suitable for powering the load 50, is output to the load 50 by the output O2 of the second boost converter SBC.

The duration of discharging the capacitor C1 can also be determined by measuring electrical values or parameters in the exemplary embodiment of the battery output extension circuit 100 or it can simply be determined by the known electrical properties of electrical components in the first exemplary embodiment of the battery output extension circuit 100. Similarly to the case for the duration of charging the capacitor C1, the duration of discharging the capacitor C1 can likewise simply be set to be equal to a first RC time constant, where C is the capacitance of the capacitor C1, but now R is the resistance of the inductor L2 in the second boost converter SBC. This results in acceptable operation since the voltage across the capacitor C1 will fall to 36.8% of its initial charge voltage during a duration equal to the first time constant.

The duration of discharging the capacitor C1 can additionally or alternatively be determined by measuring electrical values or parameters using various sensors. For example, powers and/or currents can be measured. An optimized implementation is based on determining the duration of discharging the capacitor C1 by measuring the power flowing into or out of certain points in the first exemplary embodiment of the battery output extension circuit 100. An optimized implementation is based on determining the duration of discharging the capacitor C1 by measuring the power flowing into or out of certain points in the first exemplary embodiment of the battery output extension circuit 100. As one specific example, the power flowing out of the capacitor C1 during discharging can be measured by the fourth watt meter WM4 and the duration of discharging of the capacitor C1 can be ended when the power flowing out of the capacitor C1 has fallen to a predetermined power level.

To end the duration during which the capacitor C1 is discharging, the second control signal CS2 generated by the electronic controller 30 and sent to the control terminal G2 of second switch SW2 causes the second switch SW2 to open its conductive path (i.e., causes the path to no longer be formed) to electrically interrupt the flow of charge from the capacitor C1 to the input 12 of the second boost converter SBC.

After the second switch SW2 has been opened by the second control signal CS2 supplied to the control terminal G2 of second switch SW2 by the electronic controller 30, the first control signal CS1 once again causes the first switch SW1 to close and electrically connect the DC voltage supplied by the first rechargeable battery B1 to the first terminal T1 of the capacitor C1 to thereby charge the capacitor C1 as already described. The process of charging the capacitor C1 while charging the second rechargeable battery B2, and subsequently discharging the capacitor C1 to power the load 50 is repeatedly performed until a decision is made to stop operating the first exemplary embodiment of the battery output extension circuit 100 in the first operating mode and to start operating the first exemplary embodiment of the battery output extension circuit 100 in the second operating mode.

The decision to stop operating in the first operating mode and to start operating in the second operating mode can be predetermined, for example, based on previously performed experimentation to find suitable criteria for changing from operating in the first operating mode and into the second operating mode. However, the decision to stop operating in the first operating mode and to start operating in the second operating mode is preferably made, for example, based on at least one measured value. A suitable measured value can be, for example, a measured value, for example taken by the first wattmeter WM1, of the power flowing out of the first rechargeable battery B1 and/or can be a measured value, for example taken by the second wattmeter WM2, of the power flowing into the second rechargeable battery B2.

For charging and discharging the capacitor C1, the control of the first switch SW1 and the second switch SW2 in the second operating mode is identical to that described in the first operating mode. The difference is that in the second operating mode, the second rechargeable battery B2 is connected to recharge the first rechargeable battery B1 and to charge the capacitor C1. As can be seen in FIG. 2, the fourth control signal (non-illustrated) has actuated the fourth switch SW4 to electrically connect the positive electrode E4 of the second rechargeable battery B2 to the input I1 of the first boost converter FBC by connecting the first electrode T13 of the fourth switch SW4 to the third electrode T15 of the fourth switch SW4. The third control signal (non-illustrated) has actuated the third switch SW3 to electrically connect the output O1 of the first boost converter FBC to the positive terminal of the first rechargeable battery B1 by connecting the first electrode T10 of the third switch SW3 to the second electrode T12 of the third switch SW3.

The operation of the first exemplary embodiment of the battery output extension circuit 100 in the second operating mode then continues with the first switch SW1 and the second switch SW2 operated in the same way described in the first operating mode and with reference to FIG. 1.

The electronic controller 30 may be configured, i.e., programmed to optimize the way that charge is stored on the capacitor C1 by controlling the switch SW1 based on one or more measured values. Likewise, the electronic controller 30 may optimize the way that charge is discharged from the capacitor C1 by controlling the switch SW2 based on one or more measured values.

The output signal provided at the output O1 of the first boost converter FBC is controlled by the first control signal CS1 generated by the electronic controller 30 and sent to the control terminal G1 of the first switch SW1. The output signal provided at the output O2 of the second boost converter SBC is controlled by the second control signal CS2 generated by the electronic controller 30 and sent to the control terminal G2 of the second switch SW2. The level of the voltage output by a respective boost converter FBC, SBC will increase as the frequency of the control signal (CS1 or CS2), which is sent to the respective boost converter FBC, SBC, increases. The level of the voltage output by a respective boost converter FBC, SBC will also change based on the duty cycle or the pulse width modulation (PWM) of the control signal (CS1 or CS2) that is sent to the respective boost converter FBC, SBC.

To optimize the way that charge is stored on the capacitor C1, to make the decision for when to switch from the first operating mode to the second operating mode, and to make the decision for when to switch from the second operating mode to the first operating mode, the first exemplary embodiment of the battery output extension circuit 100 can include a plurality of sensors. The plurality of sensors can be a plurality of watt meters WM1-WM4 including, for example, at least a first watt meter WM1 and a second watt meter WM4. However, the plurality of watt meters can include any number of watt meters that might be needed to enable the battery output extension circuit 100 to operate in the most effective way. For example, the plurality of watt meters WM1-WM4 can also include a third watt meter WM3 inserted into the electrically connective path between the first boost converter FBC and the capacitor C1, and/or a fourth watt meter WM4 inserted into the electrically connective path between the capacitor C1 and the second boost converter SBC.

The first watt meter WM1 provides at least one measured value selected from the group consisting of a power flowing into the first rechargeable battery B1 and a power flowing out of the first rechargeable battery B1. The second watt meter WM2 provides at least one measured value selected from the group consisting of a power flowing into the second rechargeable battery B2 and a power flowing out of the second rechargeable battery B2.

The electronic controller 30 can then be configured for controlling the switching of the first switch SW1 and the switching of the second switch SW2 based on the at least one measured value provided by the first watt meter WM1 and on the at least one measured value provided by second first watt meter WM2. Of course, the electronic controller 30 can be configured for controlling the switching of the first switch SW1 and the switching of the second switch SW2 based on one or more measured values provided by other watt meters in addition to the first watt meter WM 1 and the second watt meter WM2. For example, the electronic controller 30 can be configured for additionally or alternatively controlling the switching of the first switch SW1 and the switching of the second switch SW2 based on at least one measured value provided by the third watt meter WM3 and/or at least one measured value provided by the fourth watt meter WM4. The third watt meter WM3 can provide a measured value indicating the power flowing into the capacitor C1 while the capacitor C1 is undergoing charging, and the fourth watt meter WM4 can provide a measured value indicating the power flowing out of the capacitor C1 while the capacitor C1 is discharging to power the load 50.

The control terminal G1 of the first switch SW1 is supplied with the first control signal CS1 from the electronic controller 30 to actuate the first switch SW1. The control terminal G2 of the second switch SW2 is supplied with the second control signal CS2 from the electronic controller 30 to actuate the second switch SW2. When the first switch SW1 is implemented as a field effect transistor, the first control signal CS1 supplied to the control terminal G1, i.e., the gate, from the electronic controller 30 will control whether a conductive path is formed between the source and the drain of the of the field effect transistor.

The first boost converter FBC shown in FIG. 1 is a switched mode DC-DC converter that converts the voltage supplied by one of the batteries (B1, B2) to a higher voltage that is sufficient to charge the other one of the batteries (B2, B1). The second boost converter SBC shown in FIG. 1 is a switched mode DC-DC converter that converts the voltage discharged by the capacitor C1 to a higher level that is sufficient to power the load 50.

The first boost converter FBC and the second boost converter SBC can each be constructed in any way known to those in the art. In the first exemplary embodiment of the battery output extension circuit 100 shown in FIG. 1, the first boost converter FBC is constructed with the first switch SW1, an inductor L1, a diode 60, and a capacitor C1. The first terminal LT1 of the inductor L1 forms the input I1 of the first boost converter FBC, and the second terminal LT2 of the inductor L1 is connected to a node that is also connected to the anode of the diode 60. The first terminal D1 of the first switch SW1, which can be electrically connected to a conduction path that is switchably formed in the first switch SW1, is also connected to the node (note the optional third watt meter WM3 is shown connected between first terminal D1 and the node). The first terminal CT1 of the capacitor C2 in the first boost converter FBC is connected to the cathode of the diode 60 and the node formed by that connection forms the output O1 of the first boost converter FBC.

In the first exemplary embodiment of the battery output extension circuit 100 shown in FIG. 1, the second boost converter SBC is constructed with the second switch SW2, an inductor L2, a diode 70, and a capacitor C1. The first terminal LT3 of the inductor L2 forms the input 12 of the second boost converter SBC, and the second terminal LT4 of the inductor L2 is connected to a node that is also connected to the anode of the diode 70. The first terminal D2 of the second switch SW2, which can be electrically connected to a conduction path that is switchably formed in the second switch SW2, is also connected to the above-described node.

The first terminal CT4 of the capacitor C3 in the second boost converter SBC is connected to the cathode of the diode 70 and the node formed by that connection forms the output O2 of the second boost converter SBC.

One preferred application is to use the first exemplary embodiment of the battery output extension circuit 100 (and all exemplary embodiments) to power a load 50 in the form of an electric motor M, for example, an electric motor providing motive force to move a vehicle. However, the invention should not be construed as being limited to that application. The first exemplary embodiment of the battery output extension circuit 100 (as well all exemplary embodiments) can be used to supply energy to a multiplicity of components, for example, household appliances, to power a residential building, such as a house or apartment, to power an office building, or to power other types of commercial buildings.

An important point to understand is that the first exemplary embodiment of the battery output extension circuit 100 (and all exemplary embodiments) can be made to satisfy the power requirements of a plethora of applications by suitably using a particular number of batteries in place of the first rechargeable battery B1, by suitably using a particular number of batteries in place of the second rechargeable battery B2, and by connecting an appropriate number of capacitors in place of the single capacitor C1 in the first exemplary embodiment of the battery output extension circuit 100 shown in FIG. 1.

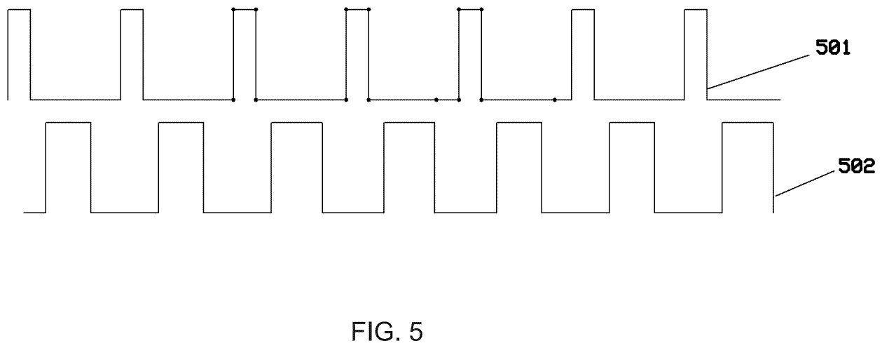

FIG. 5 is a diagram showing waveforms for controlling the first switch SW1 and the second switch SW2. Waveform 501 is an example of the first control signal CS1 for controlling the first switch SW1 and waveform 502 is an example of the second control signal CS2 for controlling the second switch SW2. Note the delays between the falling edges of the pulses in waveform 501 in relation to the rising edges of the pulses in waveform 502. This ensures that the switch SW1 turns off before the switch SW2 turns on.

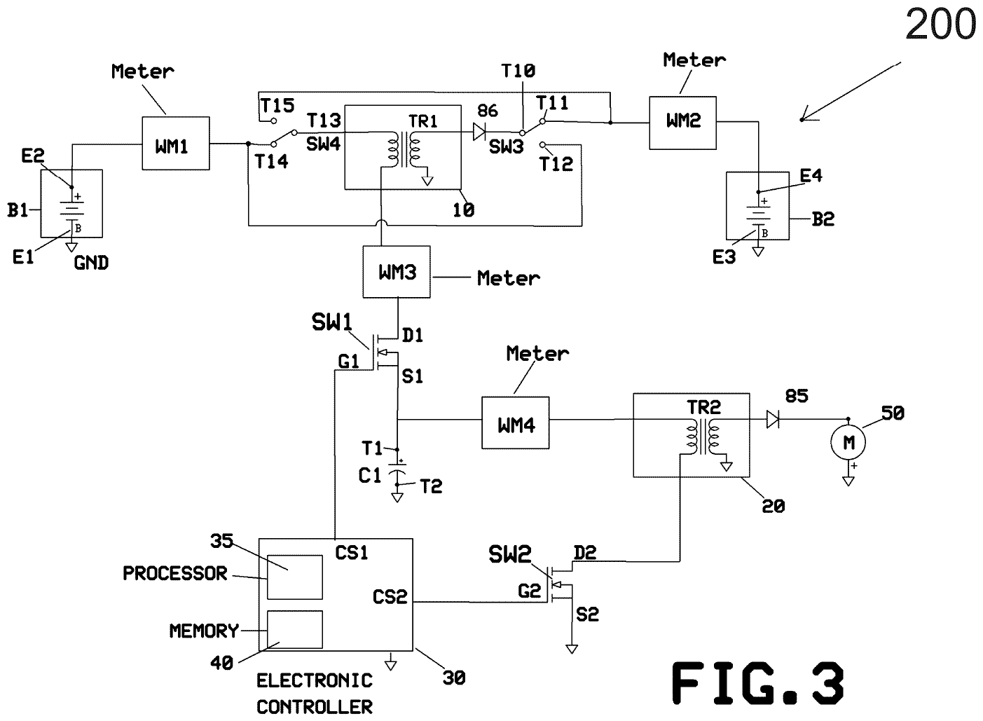

FIG. 3 is a schematic diagram of a second exemplary embodiment of the battery output extension circuit 200. Components that are the same as those in the first exemplary embodiment of the battery output extension circuit 100 are identified using the same reference characters. Any modifications and/or applications to power specific loads described regarding the first exemplary embodiment of the battery output extension circuit 100 also apply to the second exemplary embodiment of the battery output extension circuit 200.

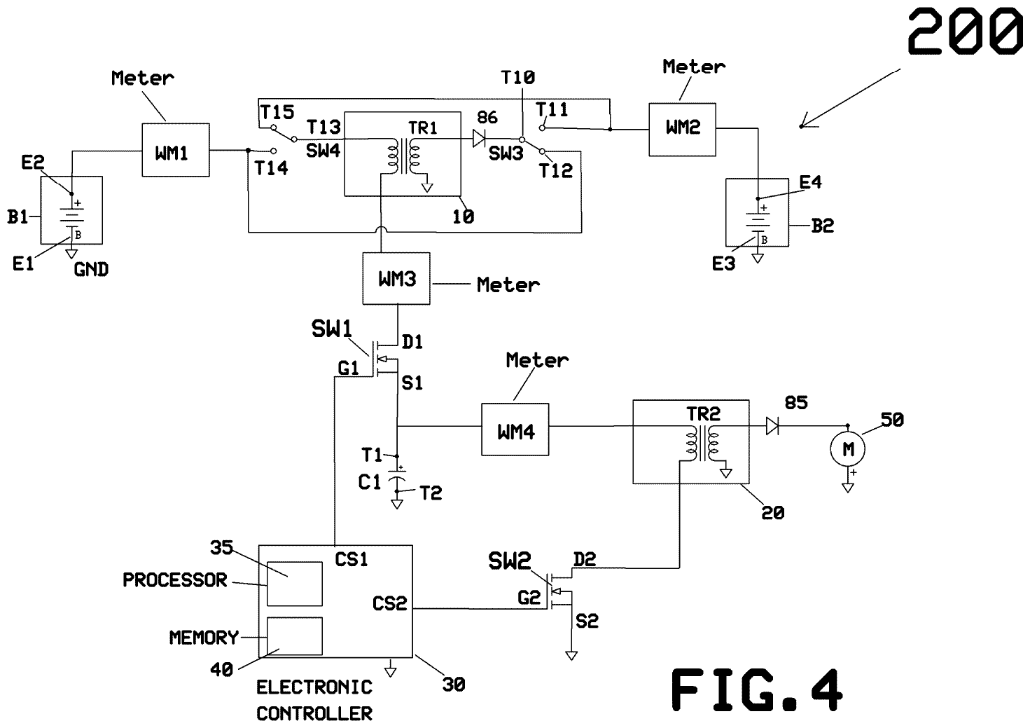

FIG. 3 shows the second exemplary embodiment of the battery output extension circuit 200 switched into and operating in the first operating mode in which energy from the first rechargeable battery B1 is used to charge the second rechargeable battery B2 and the capacitor C1. FIG. 4 is a schematic diagram of the second exemplary embodiment of the battery output extension circuit 200 shown switched into and operating in the second operating mode in which energy from the second rechargeable battery B2 is used to charge the first rechargeable battery B1 and the capacitor C1. The second exemplary embodiment of the battery output extension circuit 200 operates almost identically to the first exemplary embodiment of the battery output extension circuit 100 shown in FIG. 1.

The difference is that the first voltage level booster 10 is now implemented as a first transformer TR1, and the second voltage level booster 20 is now implemented as a second transformer TR2. The first voltage level booster 10 has an input (the upper terminal of the primary winding) and an output (the upper terminal of the secondary winding). The second voltage level booster 20 has an input (the upper terminal of the primary winding) and an output (the upper terminal of the secondary winding) providing an output voltage for the load M. A diode 80 is connected between the upper terminal of the secondary winding of the first transformer TR1 and the first terminal T10 of the third switch SW3. A diode 85 is connected between the upper terminal of the secondary winding of the second transformer TR2 and the load 50.

The charging and discharging of the capacitor C1 in the second exemplary embodiment of the battery output extension circuit 200 is controlled in the way already described regarding the first switch SW1 and the second switch SW2 in the first exemplary embodiment of the battery output extension circuit 100.

The first exemplary embodiment of the battery extension circuit 100 and the second exemplary embodiment of the battery extension circuit 200 are each constructed to operate based on the principles of the third form of current that Maxwell called displacement current. Referring again to the first exemplary embodiment of the battery extension circuit 100 shown in FIG. 1, the first switch SW1 and the second switch SW2 are switched to operate the battery extension circuit 100 in the first operating mode in which the second rechargeable battery B2 is charged from energy supplied by the first rechargeable battery B1. As the second rechargeable battery B2 is charged from energy supplied by the first rechargeable battery B1, an electric current flows through the inductor L1 of the first boost converter FBC and the voltage, which is at the node connecting the inductor L1 and the anode of the diode 60, is also applied to the first terminal T1 of the capacitor C1 to charge the capacitor C1. The gain of work done through the inductor L1 of the first boost converter FBC is now stored in the capacitor C1 based on the principles of the third form of current that Maxwell called displacement current. The circuit is completed by connecting the second terminal T2 of the capacitor C1 to the reference potential GND which is ground. Notably, the current passes through the inductor L1 of the first boost converter FBC, and the inductor L1 is characterized by a significantly low resistance. This inductor L1 serves to fine-tune the power level that is output by the first boost converter FBC in dependence on the pulse frequency and duty cycle of the first control signal CS1, i.e., pulses sent to the control terminal G1 of the first switch SW1. In this way, the power level can be aligned with the resistance of a primary load, which in this case is the second rechargeable battery B2 that receives a voltage from the first boost converter FBC. The first rechargeable battery B1, second rechargeable battery B2, first voltage booster, and capacitor C1 can be thought of as a primary circuit in which the battery (B2 in FIG. 1, but B2 in FIG. 2) being charged is the primary load.

It is preferable to adjust the duty cycle of the of the first control signal CS1 supplied to the first switch SW1 since the potential energy stored in the capacitor C1 is so much lower compared to the charging potential obtained from the batteries B1, B2. This adjustment entails an increase in the duty cycle to ensure the complete discharge of the capacitor C1 before commencing the subsequent charging cycle.

An electric field is formed between the plates of the capacitor C1, and this electric field serves to charge the capacitor C1. Then, the charging of the second rechargeable battery B2 by the first rechargeable battery B1 is temporarily interrupted, and the capacitor C1 is discharged to power the load 50. At a certain point, the discharging of the capacitor C1 will be stopped and the charging of the second rechargeable battery B2 by the first rechargeable battery B1 will resume-along with charging of the capacitor C1. This alternating process of charging the second rechargeable battery B2 and the capacitor C1, and then interrupting the charging process while discharging the capacitor C1 to power the load 50 is repeated until a time at which the first rechargeable battery B1, which was providing the charging energy, will now be charged by the second rechargeable battery B2. Notably, there is no actual flow of electrical charge across the plates of the capacitor C1 during the described process. Rather, as introduced by Maxwell, the concept of “displacement current” explains the change in electric field (JE/at) in regions where there is no actual flow of electric charge (i.e., where p=0). In other words, displacement current accounts for the changing electric field in regions of space where there are no traditional electric currents (i.e., moving charges). The energy from the electric field, which is produced without the flow of a traditional electric current through the capacitor C1, can advantageously be used to power the load 50. This energy can advantageously be used to extend the power available from the first rechargeable battery B1 because the energy from the first rechargeable battery B1 is directly used to charge the second rechargeable battery B2 and at the same time, based on Maxwell's concept of displacement current, energy is stored in the capacitor C1. Due to this unique and novel property of electromagnetic energy, electric energy is recycled without violating the law of conservation of energy. The concept just described is also true when the first switch SW1 and the second switch SW2 are switched to operate the battery extension circuit 100 in the second operating mode in which the second rechargeable battery B2 is charged from energy supplied by the first rechargeable battery B1.

Due to the nature of the capacitor C1 and electro-elasticity, as Maxwell called it, energy that is used to make the primary circuit work also gets stored in the capacitor C1. The energy that is stored in the capacitor C1 follows the law of conservation of energy. This energy stored in the capacitor C1 can then be used to extend the time required until the first rechargeable battery B1, the second rechargeable battery B2, or a respective battery bank used instead of one of the mentioned batteries requires charging, and/or it can be used to obtain an output power that would otherwise have required a greater number of batteries or battery banks if a battery output extension circuit, such as, the first exemplary embodiment of the battery extension circuit 100 or the second exemplary embodiment of the battery extension circuit 200 were not used.

The first exemplary embodiment of the battery extension circuit 100 and the second exemplary embodiment of the battery extension circuit 200 can each be used to increase the time, compared to the prior art, during which the first rechargeable battery B1 and the second rechargeable battery B2 can provide power to a load 50 or device before the first rechargeable battery B1 and the second rechargeable battery B2 require charging by some type of external charging station, charging device, or perhaps from the electrical grid.

The first exemplary embodiment of the battery extension circuit 100 and the second exemplary embodiment of the battery extension circuit 200 can also be used to reduce the number of batteries or battery banks required for a particular application and/or to reduce the size of the batteries (batteries with a lower number of cells) and/or battery banks (battery banks with a lower number of batteries) compared to the prior art.

In other words, an electric car that needs, for example, 100 batteries to travel 100 miles can be made to use a lower number of batteries, perhaps 75 or less to travel the same distance. All the energy that one battery has used to charge another battery is now stored in the capacitor C1 and is used to power an external load 50 due to the storage of the displacement current in the capacitor C1 and the electro elasticity process stored in the capacitor C1-energy is in a sense recycled.

The first exemplary embodiment of the battery extension circuit 100 and/or the second exemplary embodiment of the battery extension circuit 200 can be part of an electric vehicle, for example, an electric automobile, and can be used to extend the driving range of the electric vehicle. The extended range results since the first exemplary embodiment of the battery extension circuit 100 and the second exemplary embodiment of the battery extension circuit 200 use the unique properties of the capacitor C1 and use the first rechargeable battery B1 and the second rechargeable battery B2 to recharge each other instead of directly powering the load 50.

This, of course, is advantageous since the electric vehicle can now travel a greater distance before the first rechargeable battery B1 and the second rechargeable battery B2 or battery banks need to be charged by a charging device located externally from the electric vehicle. Since the exemplary embodiments of the battery extension circuit 100, 200 use a capacitor C1 on the ground side of the circuit, the battery extension circuit 100, 200 does work by charging the first rechargeable battery B1 from the second rechargeable battery B2 or by charging the second rechargeable battery B2 from the first rechargeable battery B1 while at the same time charging the capacitor C1 and storing the energy required to do the work in the capacitor C1. Using this novel and unique property of displacement current that is now stored in the plates of the capacitor C1, the energy in the capacitor C1 can then be discharged into another load 50, preferably a low resistance inductor or motor M, however, the load 50 can be any device.

The recycled power, which is stored in the capacitor C1, can enable a lower number of batteries or battery banks and/or smaller batteries or battery banks to be used to power electrical loads of an electric vehicle. The batteries or battery banks can supply power to any or all electrical loads or electric devices of the electric vehicle. For example, the batteries or battery banks can supply power to a particular load 50, such as, the electric motor M that provides the motive force needed to move the electric vehicle from one location to another.

The first exemplary embodiment of the battery extension circuit 100 and/or the second exemplary embodiment of the battery extension circuit 200 can also be used to extend the time that batteries or battery banks can be used to supply power to one or more electrical devices or loads in a building, such as, a residential or office building.

Since the first exemplary embodiment of the battery extension circuit 100 and the second exemplary embodiment of the battery extension circuit 200 each increase the power output available from the batteries or battery banks powering the loads in the building, those loads can be powered for a longer period of time before the energy in the batteries or battery banks is used up which then requires charging, for example, using energy from the electrical grid.

Since the first exemplary embodiment of the battery extension circuit 100 and the second exemplary embodiment of the battery extension circuit 200 each extend the power output available from the batteries or battery banks powering one or more loads of the building, the extended power can alternatively or additionally enable a lower number of batteries or battery banks and/or smaller power capacity batteries or battery banks to be used to power the loads of the building.

All the electrical loads in the building or perhaps only a few electrical loads, such as, the air conditioning unit, the refrigerator, and basic lighting can be powered.

If the level of the voltage stored in the capacitor C1 is high enough, no boosting of the level of the voltage is required. Thus, the second voltage level booster 20, which can be implemented as a boost converter, a step-up transformer, a coil, or a combination of such components, can be eliminated. In this case, the load 50, such as, an inductor, transformer, or electric motor can be directly driven by the energy stored internally in the capacitor C1 by closing switch SW2 to complete a path for a current to flow through the load 50 and then to reference potential GND which is preferably ground.

Before starting a battery charge and discharge cycle (i.e. the first operating mode or the second operating mode), both the first rechargeable battery B1 and the second rechargeable battery B2 (or if battery banks are used, then both battery banks) have already been fully charged by an external charging device, and one of the rechargeable batteries B1, B2 has been used to power the load 50.

Let us consider the case in the first exemplary embodiment of the battery extension circuit 100 where the second rechargeable battery B2 has been used to power the load 50 and requires recharging. The first exemplary embodiment of the battery extension circuit 100 is then operated in the first operating mode in which the first rechargeable battery B1 or battery bank charges the second rechargeable battery B2 or battery bank, respectively. The first control signal CS1 includes pulses that are sent to the control terminal G1 of the first switch SW1. The pulses have a duty cycle and a frequency calculated by the processor 35 of the electronic controller 30 based on measured values provided by the plurality of watt meters WM1-WM4. The processor 35 may calculate the most efficient current flow through the load 50 or through the inductor L1 of the first boost converter FBC used to increase the level of the voltage provided by the first rechargeable battery B1 or battery bank to charge the second rechargeable battery B2 or battery bank, respectively.

When the first boost converter FBC is used to increase the voltage for charging the first rechargeable battery B1, the second rechargeable battery B2, or a battery bank, the first boost converter FBC also simultaneously provides pulsed energy to the first terminal T1 of the capacitor C1 to charge the capacitor C1. The second terminal T2 of the capacitor C1 is connected to reference potential GND which is ground. Due to the unique property of the capacitor C1 explained by Maxwell as displacement current theory, the pulsed energy stored in the capacitor C1 can be discharged by the second control signal CS2, i.e. pulses sent to the control terminal G2 of the second switch SW2 using a duty cycle and a frequency calculated by the processor 35 from measured values acquired from the plurality of watt meters WM1-WM4. In this way, the capacitor C1 provides power to the load 50. The power and charge provided by the first rechargeable battery B1 to charge the second rechargeable battery B2 or provided by the second rechargeable battery B2 to charge the first rechargeable battery B1 (or battery banks) will eventually decrease with every charge and discharge cycle due to electrical loses and inefficiencies inherent in all electrical circuit systems. Lithium polymer batteries have charging efficiencies from 85 to 95% so 5 to 15% would be lost to heat and other factors. A typical switched mode DC-DC converter has an efficiency of between 85 and 90%, which can be enhanced to 90 to 95% by implementing soft switching.

The battery charge and discharge cycles can be used more than four times, but the number of cycles will be determined by the application and by the type of first and second rechargeable batteries B1, B2 being used. Eventually every cycle will reduce the battery charge before they need to be fully charged and start from the beginning again. The range of an electric vehicle will be greatly increased before the process needs to start over from the beginning again. The exemplary embodiments of the battery extension circuit 100, 200 enable the energy in the first and second rechargeable batteries B1, B2 or battery banks to be used several times thus increasing the operating time of any DC battery powered system.

The law of conservation of energy states that energy can neither be created nor destroyed; energy can only be converted from one form of energy to another form of energy. This means that a system always has the same amount of energy, unless energy is added from outside the system. This can be confusing, for example, where energy is converted from mechanical energy into thermal energy with the overall energy remaining the same. The only way to use energy is to transform energy from one form to another form. The exemplary embodiments of the battery extension circuit 100, 200 each reuse stored energy (obeying the law of conservation of energy) by changing electromagnetic energy into a displacement current stored in the capacitor C1 and then by changing the displacement current back into electromagnetic energy. The energy from one of the first and second rechargeable batteries B1, B2 that is used to charge another one of the first and second rechargeable batteries B1, B2 is used in one form and is then reused in another form, and this extends the power output that is available from the first and second rechargeable batteries B1, B2 for powering the load 50.

In a building, any battery powered loads can be powered for a longer period of time by using the battery output extension circuit 100, 200, before the energy in the first and second rechargeable batteries B1, B2 is completely used up which then requires external energy, for example, from the electrical grid for charging the first and second rechargeable batteries B1, B2 and powering the load 50. Since the battery extension circuit 100, 200 recycles electricity, the power output available from the first and second rechargeable batteries B1, B2 powering one or more loads 50 of the building is extended. The extended available power output can enable a lower number of batteries and/or smaller power capacity batteries to be used to power one or more loads 50 in the building. All the electrical loads in the building or perhaps only a few electrical loads, such as, the air conditioning unit, the refrigerator, and basic lighting can be powered.

The electric operating cost of homes and buildings can be reduced by using the battery output extension circuit 100, 200 since energy from the electric grid is only needed to replace energy lost by the inefficiencies of one or more loads 50, the first and second rechargeable batteries B1, B2, and the other components of the battery output extension circuit 100, 200. Every charge and discharge cycle will require 15 to 20% outside power from the grid to restore the first and second rechargeable batteries B1, B2 to full charge. Every charge and discharge cycle will only be able to charge the first and second rechargeable batteries B1, B2 to 80 to 85% of its full charge due to all the inefficiencies.

For example, lithium polymer batteries have efficiencies of 80 to 95%, switched mode DC-DC converters have efficiencies of 80 to 95%, and DC to AC invertors have efficiencies of about 96%. The exemplary embodiments of the battery output extension circuit 100, 200 can operate at efficiencies of 65 to 85%. This means that every charge and discharge battery cycle will require 35% to 15% (depending on the batteries used) of additional power from the grid to operate at maximum power output while drastically reducing cost.

Another example of use in a building is using the battery extension circuit 100, 200 in a building that is powered by photovoltaic panels, i.e., solar panels. In this example, the number of photovoltaic panels required to power the building can be reduced compared to the prior art. The first and second rechargeable batteries B1, B2 or battery banks may be used to power the building and the photovoltaic panels may provide an additional 35% to 15% of energy to keep the batteries fully charged and operate the battery extension circuit 100, 200 under maximum output.

The battery extension circuit 100, 200 can be part of a portable power system that can be used, for example, to power one or more loads 50 of a building. Such a portable power system can power, for example, power tools or any electrical load 50 requiring electrical power.

An electric car like the Tesla™ Model S™ has a typical range of 348 miles. This range can be increased when using the battery extension circuit 100, 200. If two battery banks of a plurality of batteries are used, the first rechargeable battery bank can provide a range of 174 miles, and the second rechargeable battery bank can provide a range of 174 miles. However, when the battery extension circuit 100, 200 is used, those ranges are increased, and each battery charging cycle (i.e. first operating mode or second operating mode) adds a certain range. If the first rechargeable battery bank charges the second rechargeable battery bank to 75% of its original charge, then in a first charging cycle (i.e. first operating mode) during which the first rechargeable battery bank charges the second rechargeable battery bank, the range is increased by 75%×174 miles=130 miles. In a second charging cycle (i.e. second operating mode) during which the second rechargeable battery bank charges the first rechargeable battery bank, the range is increased by 75%×130 miles=97 miles. In a third charging cycle during which the first rechargeable battery bank charges the second rechargeable battery bank, the range is increased by 75%×97 miles=72 miles. In a fourth charging cycle during which the second rechargeable battery bank charges the first rechargeable battery bank, the range is increased by 75% of 72 miles=54 miles. Thus, the total range available when using four charging cycles=174+174+130+97+72+54=701. The total range available when using eight battery charging cycles=174+174+130+97+72+54+40+30+22+16−809 miles.

As another example, the same range can be traveled with battery banks that are half the size required in the prior art. Given that the range of the first rechargeable battery bank=90 Miles and the range of the second rechargeable battery bank=90 Miles, then the additional range can be 90×75%=67; 67×75%=50, 50×75%=37, and 37×75%=27. Thus, the total range is 90+90+67+50+37+27=361 miles with battery banks that are half the size of the battery banks required in the prior art.

The exemplary embodiments of the battery extension circuit 100, 200 can be implemented as part of any consumer device that is powered by batteries or battery banks. In this way, the consumer device is the load 50 powered by the battery extension circuit 100, 200. For example, the battery extension circuit 100, 200 can be implemented in a cellular phone. Thus, the battery extension circuit 100, 200 can increase the time that the cellular phone can be operated before the batteries or battery banks of the cellular phone require charging by an external charging device. Similarly to the way already described, the number of batteries or battery banks and/or the size of the batteries or battery banks needed to supply power to the cellular phone can be reduced compared to the prior art with the output rating of the batteries or battery banks still being sufficient to power the cellular phone.

The invention is not limited to powering the given examples of electrical loads, such as, electrical loads in an electric vehicle, electrical loads in a building, electrical loads in consumer devices, and electrical loads powered by portable power systems.

The electronic controller 30 can monitor the operation of the battery output extension circuit 100, 200 and may control a graphical user interface (GUI) to provide one or more visual signals indicating the state of the operation of the battery output extension circuit 100, 200. For example, the GUI can graphically show the state of charge of the first rechargeable battery B1 bank and the second rechargeable battery B2. The electronic controller 30 may additionally or alternatively provide audible signals indicating the state of the operation of the battery output extension circuit 100, 200. The electronic controller 30 may also identify faults and visually indicate the faults on the Gui or audibly indicate such faults. The electronic controller 30 may also shut down the battery output extension circuit 100, 200 upon determining that a dangerous fault exists and thereby protect against potential fires.

The processor 35 of the electronic controller 30 can be programmed to implement an algorithm to control the timing of the switching of the first switch SW1 and the second switch SW2.

There are several ways for controlling the timing of the switching of the first switch SW1 and of the second switch SW2 using the processor 35 of the electronic controller 30. An algorithm, which is different from the algorithm that has already been described, may be used. One example of a different algorithm that can be implemented in the processor 35 of the electronic controller 30, may be based on determining an optimized frequency and Pulse Width Modulation (PWM) depending on the resistance of the load 50. System data from sensors (non-illustrated) can measure the resistance in the circuit and then select an optimized frequency and PWM.

The processor 35 of the electronic controller 30 can increment the voltage level pulses applied to a respective switch SW1, SW2 until the maximum power level is reached. A non-limiting example that can be used to obtain the maximum power level is explained below. The voltage can be increased, for example, by using boost converters (switched mode DC-DC converters). Using switched mode DC-DC converters increases the voltage and power levels. Each switched mode DC-DC converter can be controlled by having the processor 35 of the electronic controller 30 increment the duty cycle or the PWM in the circuit based on measured values from sensors or based on measured values from the Watt meters.

Additionally or alternatively, the voltage can also be increased by replacing each of the first and second rechargeable batteries B1 and B2 with a respective battery bank having a plurality of batteries connected in series. The number of batteries connected in series can be increased until the desired power level is reached. If this option is used, each battery cell may have electronics in a battery control module for power output and charging. Lithium polymer batteries are already sold and manufactured with the current charge protection electronics. Adding only a few more components to the final manufactured product may be required.

However, switched mode DC-DC converters are very efficient and can be easily controlled with the processor 35 of the electronic controller 30 to increase or decrease power by controlling the PWM of the inductor that is part of the switched mode DC-DC converter. If this option is used, the processor 35 of the electronic controller 30 may control the on-off time of each switched mode DC-DC converter to achieve the desired power level. This system reduces the number of components required for the final assembly. The higher the voltage and the frequency, the higher the system's power output. Each battery or section may have a control unit installed and connected as part of its production. The processor 35 of the electronic controller 30 can be a master controller and can control the entire system, but the circuit may need as many drive circuits as required by the power requirements.

The circuit can use as many switches, preferably MOSFETs and capacitors connected in parallel combinations as required to control the power level output using multiple drivers and capacitor designs.

Note that diodes can be used to isolate one capacitor from another capacitor connected in parallel. The system can use one or multiple capacitors that can be turned on one or more at a time in any combination required to provide the desired power level output. Appropriate switches (analogous to SW1) can be turned on simultaneously to charge the multiple capacitors, and then after those switches are turned off, appropriate switches (analogous to SW2) can be turned on simultaneously on the discharge side to discharge the energy stored in the multiple capacitors into the load 50. Also, multiple switches can be utilized to charge the multiple capacitors, but only one switch needs to be used be utilized to discharge the multiple capacitors into the load 50 (although multiple switches can be used if desired). The measured data can be used by the processor 35 of the electronic controller 30 to control and execute the circuit sequence and combinations. Controlling the circuit this way can help prevent the switches from overheating when implemented as MOSFETs in high load 50 demand situations.

The voltage on the load 50 is preferably at least three times higher than the voltage that the charge side of the circuit uses. The pulse width (on Time) may be short on the charge side, but longer on the discharge side. The voltage stored in the capacitor C1 can only be equal to the voltage drop across the load 50. For example, when using a 12-volt, 100 Watt DC motor as a load 50, the circuit may provide 36 volts to run the motor. The voltage drop across the motor and the voltage across the capacitor C1 may each be 12 volts. The voltage from the battery or batteries being discharged can be supplied, for example, to a voltage level booster, for example, a switched mode DC-DC converter to boost the voltage used to charge the battery or batteries being charged. At minimum, the voltage used to charge the battery or batteries being charged should be the required charging battery voltage. A tuned switched mode DC-DC converter may be ideal.

The pulse going to the switch or perhaps switches controlling the energy being discharged to the load 50 can be of a duration, for example, 5% of the entire duration available for a switching cycle, and the pulse controlling the switch or perhaps switches controlling the energy being discharged from one battery or battery bank to charge another battery or battery bank and the capacitor C1 or perhaps multiple capacitors can be of a duration, for example, 95% of the entire duration available for the switching cycle.

For example, if the duty cycle for discharging the capacitor C1 or capacitors to the load 50 is 5% and the voltage supplied to the load 50 is 36 V, the duty cycle used to charge a battery or a battery bank and the capacitor C1 from another battery or battery bank would be 95%. The increases in duty cycle are because there is lower voltage in the capacitor C1, and the capacitor C1 should be suitable discharged before another charging cycle is started (See FIG. 4).

The voltage and the resistance of the load 50 or loads may determine the percentage difference in the Duty cycle or PWM between the charge side and discharge side of the capacitor C1 or capacitors.

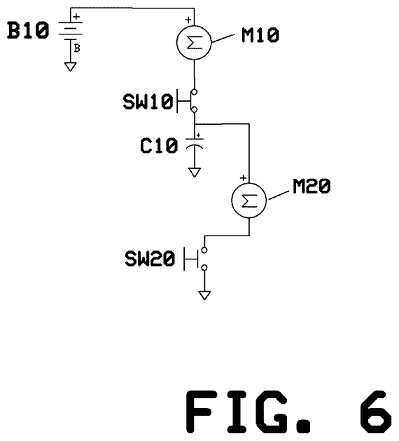

FIG. 6 shows a circuit that was used to perform an experiment demonstrating that displacement current can enhance the performance of batteries and battery-operated devices. Two identical windshield washer pumps M10 and M20, like those used in cars, were used to pump water into respective 250 ml graduated cylinders (not shown) while simultaneously storing all the energy in a capacitor C10. After the capacitor C10 was fully charged, the water volume pumped into the cylinder by the washer pump M10, as a result of actuating switch SW10, was measured and recorded. The capacitor C10 was then connected to the other washer pump M20, as a result of actuating switch SW20, and the capacitor C10 was discharged until the washer pump M20 ceased pumping water. The two measurements were compared to evaluate the results. According to the behavior of capacitor C10, the results should be nearly identical. The measured results of the experiment are detailed below.

The battery B10 has a battery voltage of 12.98 volts. Each windshield washer pump M10 and M20 is a 12 Volt automotive windshield washer pump with 1.1 ohms of resistance. The capacitor C10 represents 5 capacitors connected in series in which each capacitor is a 2.7 Volt, 20 farad capacitor. Thus, the total voltage across capacitor C10 is 13.5 volts. Two momentary push button switches SW10 and SW20 are used to actuate the circuit. Two non-illustrated 250 milliliter graduated cylinders were used. One of the non-illustrated cylinders received water by the action of the windshield washer pump M10, and the other non-illustrated cylinder received water by the action of the other windshield washer pump M20.

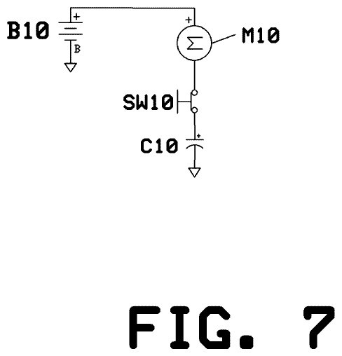

FIG. 7 shows the components that are active in FIG. 6 when the switch SW10 is closed to form an electrical connection between its terminals. When the switch SW10 was pressed to activate the windshield washer pump M10, a non-illustrated graduated cylinder was filled with water due to the action of the windshield washer pump M10. The switch SW10 is a momentary switch and was held down to close the switch SW10 and charge the capacitor C10 until the capacitor C10 was fully charged and the windshield washer pump M10 stopped operating completely. After the windshield washer pump M10 stopped operating, the graduated cylinder was filled with 205.7 milliliters of water. The process required 23.87 seconds for the capacitor C10 to fully charge and for the windshield washer pump M10 to come to a complete stop.

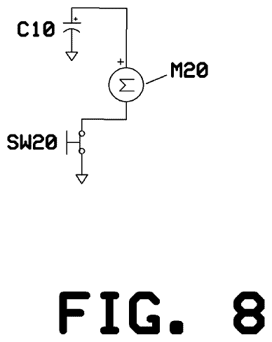

FIG. 8 shows the components that are active in FIG. 6 when the switch SW20 is closed to form an electrical connection between its terminals. When the switch SW20 was pressed to activate the windshield washer pump M20, another non-illustrated graduated cylinder was filled with water due to the action of the windshield washer pump M20. The switch SW20 is a momentary switch, and was held down to close the switch SW20 and discharge the capacitor C10 until the capacitor C10 was fully discharged and the windshield washer pump M20 stopped operating completely. After the windshield washer pump M20 stopped operating, the graduated cylinder was filled with 197.7 milliliters of water. The process required 26.87 seconds for the capacitor C10 to fully discharge and for the windshield washer pump M20 to come to a complete stop.

The experiment demonstrates that the invention disclosed herein operates as described, and that displacement current can be used in any battery operated device. The main circuit is the functioning part that will make any battery-operated device extend its output through the described method. The loads and pulses can all be changed with different components and values, but the underlying operation will always be the same.

I claim:

1. A battery output extension circuit, comprising:
a first rechargeable battery having an electrode electrically connected to a reference potential and having a further electrode;
a second rechargeable battery having an electrode electrically connected to the reference potential and having a further electrode;
a first boost converter having an input and an output;
a first switch implementing a switching required for voltage boosting in the first boost converter;
a second boost converter having an input and an output providing an output voltage for a load;
a second switch implementing a switching required for voltage boosting in the second boost converter;
a capacitor having a terminal connected to the reference potential and having a further terminal connected to the input of the second boost converter;
a third switch SW3 having a terminal connected to the further electrode of the first rechargeable battery, a terminal connected to the further electrode of the second rechargeable battery, and a terminal connected to the output of the first boost converter, the third switch configured for selectively connecting the further electrode of the second rechargeable battery to the output of the first boost converter and for alternately selectively connecting the further electrode of the first rechargeable battery to the output of the first boost converter;
a fourth switch having a terminal connected to the further electrode of the first rechargeable battery, a terminal connected to the further electrode of the second rechargeable battery, and a terminal connected to the input of the first boost converter, the fourth switch configured for selectively connecting the further electrode of the first rechargeable battery to the input of the first boost converter and for alternately selectively connecting the further electrode of the second rechargeable battery to the input of the first boost converter; and
an electronic controller configured for controlling the fourth switch such that an electrode selected from the group consisting of the further electrode of the first rechargeable battery and the further electrode of the second rechargeable battery is connected to the input of the first boost converter while concurrently controlling the third switch such that a different electrode selected from the group consisting of the further electrode of the first rechargeable battery and the further electrode of the second rechargeable battery is connected to the output of the first boost converter;
the electronic controller configured for controlling the first switch to selectively connect the further terminal of the capacitor to the first boost converter to charge the capacitor and to disconnect the further terminal of the capacitor from the first boost converter to stop charging the capacitor;
the electronic controller configured for controlling the second switch to enable a charge stored in the capacitor to be discharged into the input of the second boost converter while the further terminal of the capacitor is disconnected from the first boost converter; and
the electronic controller configured for controlling the second switch to disable the charge stored in the capacitor from being discharged into the input of the second boost converter.

2. The battery output extension circuit according to claim 1, wherein the reference potential is at a ground potential.

3. The battery output extension circuit according to claim 1, wherein the electronic controller is configured to control the first switch and the second switch by controlling a frequency and/or a duty cycle of control signals supplied to the first switch and the second switch.

4. The battery output extension circuit according to claim 3, wherein the electronic controller is configured to determine the frequency and/or the duty cycle of control signals based on measured values that are measured in the battery output extension circuit.

5. The battery output extension circuit according to claim 4, wherein the measured values include a power being supplied to the capacitor and/or a power supplied by the capacitor.

6. The battery output extension circuit according to claim 4, wherein the measured values include a power being supplied by a battery selected from the group consisting of the first rechargeable battery and the second rechargeable battery.

7. The battery output extension circuit according to claim 4, wherein the measured values include a power being supplied to a battery selected from the group consisting of the first rechargeable battery and the second rechargeable battery.

8. The battery output extension circuit according to claim 1, wherein the electronic controller is a processor and a memory.

9. The battery output extension circuit according to claim 1, wherein the first switch is a semiconductor switch, and the second switch is a semiconductor switch.

10. The battery output extension circuit according to claim 1, further comprising:
a first watt meter providing at least one measured value selected from the group consisting of a power flowing into the first rechargeable battery and a power flowing out of the first rechargeable battery; and
a second watt meter providing at least one measured value selected from the group consisting of a power flowing into the second rechargeable battery and a power flowing out of the second rechargeable battery;
the electronic controller configured for controlling the switching of the first switch and the switching of the second switch based on the at least one measured value provided by the first watt meter and on the at least one measured value provided by second first watt meter.

11. The battery output extension circuit according to claim 1, further comprising the load, wherein the load is an electric motor.

12. The battery output extension circuit according to claim 1, further comprising a plurality of watt meters configured for supplying measured values to the electronic controller, the electronic controller configured for controlling the first switch and the second switch based on the measured values from the plurality of watt meters.

13. The battery output extension circuit according to claim 1, further comprising a plurality of sensors configured for supplying measured values to the electronic controller, the electronic controller configured for controlling the first switch and the second switch based on the measured values from the plurality of sensors.

14. A battery output extension circuit, comprising:
a first rechargeable battery having an electrode electrically connected to a reference potential and having a further electrode;
a second rechargeable battery having an electrode electrically connected to the reference potential and having a further electrode;
a first voltage level booster having an input and an output;
a second voltage level booster having an input and an output providing an output voltage for a load;
a first switch and a second switch;
a capacitor having a terminal connected to the reference potential and having a further terminal connected to the input of the second voltage level booster;
a third switch having a terminal connected to the further electrode of the first rechargeable battery, a terminal connected to the further electrode of the second rechargeable battery, and a terminal connected to the output of the first voltage level booster, the third switch configured for selectively connecting the further electrode of the second rechargeable battery to the output of the first voltage level booster and for alternately selectively connecting the further electrode of the first rechargeable battery to the output of the first voltage level booster;
a fourth switch having a terminal connected to the further electrode of the first rechargeable battery, a terminal connected to the further electrode of the second rechargeable battery, and a terminal connected to the input of the first voltage level booster, the fourth switch configured for selectively connecting the further electrode of the first rechargeable battery to the input of the first voltage level booster and for alternately selectively connecting the further electrode of the second rechargeable battery to the input of the first voltage level booster; and
an electronic controller configured for controlling the fourth switch such that an electrode selected from the group consisting of the further electrode of the first rechargeable battery and the further electrode of the second rechargeable battery is connected to the input of the first voltage level booster while concurrently controlling the third switch such that a different electrode selected from the group consisting of the further electrode of the first rechargeable battery and the further electrode of the second rechargeable battery is connected to the output of the first voltage level booster;
the electronic controller configured for controlling the first switch to selectively connect the further terminal of the capacitor to the first voltage level booster to charge the capacitor and to disconnect the further terminal of the capacitor from the first voltage level booster to stop charging the capacitor;
the electronic controller configured for controlling the second switch to enable a charge stored in the capacitor to be discharged into the input of the second voltage level booster while the further terminal of the capacitor is disconnected from the first voltage level booster; and
the electronic controller configured for controlling the second switch to disable the charge stored in the capacitor from being discharged into the input of the second voltage level booster.

15. The battery output extension circuit according to claim 14, wherein the first voltage level booster is a step-up transformer, and the second voltage level booster is a step-up transformer.

16. The battery output extension circuit according to claim 14, further comprising the load, wherein the load is an electric motor.

17. The battery output extension circuit according to claim 14, further comprising a plurality of watt meters configured for supplying measured values to the electronic controller, the electronic controller configured for controlling the first switch and the second switch based on the measured values from the plurality of watt meters.

18. The battery output extension circuit according to claim 14, further comprising a plurality of sensors configured for supplying measured values to the electronic controller, the electronic controller configured for controlling the first switch and the second switch based on the measured values from the plurality of sensors.
